(19) United States
(12) Patent Application Publication
(10) Pub. No.: US 2007/0185712 A1
(43) Pub. Date: Aug. 9, 2007

(54) Method, apparatus, and medium for measuring confidence about speech recognition in speech recognizer

(75) Inventors: Jae-Hoon Jeong, Yongin-si (KR); Kwang Cheol Oh, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/477,628

(22) Filed: Jun. 30, 2006

(30) Foreign Application Priority Data
Feb. 9, 2006 (KR) 10-2006-0012527

(51) Int. Cl. G10L 15/00

(52) U.S. Cl. 704/238; 704/240

(57) ABSTRACT

A method of measuring confidence of speech recognition in a speech recognizer compares a phase change point with a phoneme string change point and uses a difference between the phase change point and the phoneme string change point and a likelihood ratio, and an apparatus using the method is provided. That is, the method of the present invention includes detecting a phase change point of a speech signal; detecting a phoneme string change point according to a result of speech recognition; calculating confidence of the speech recognition by using a difference between the detected phase change point and phoneme string change point. According to the present invention, a performance of measuring confidence may become improved by simultaneously taking not only a likelihood ratio, but also taking a comparison result of a phase change point with a phoneme string change point into consideration.

### CROSS-REFERENCE TO RELATED APPLICATIONS

This application claims the benefit of Korean Patent Application No. 10-2006-0012527, filed on Feb. 9, 2006, in the Korean Intellectual Property Office, the disclosure of which is incorporated herein by reference.

### BACKGROUND OF THE INVENTION

1. Field of the Invention

The present invention relates to a method of measuring confidence of speech recognition in a speech recognizer and an apparatus using the method, and more particularly, to a method of measuring confidence of speech recognition by comparing a phase change point of an input speech signal and a phoneme string change point according to a result of speech recognition and using a difference between the phase change point and the result of speech recognition and a likelihood ratio, and an apparatus using the method.

2. Description of the Related Art

In an automatic speech recognition system using a conventional technique, as an example of a method of rejecting a false hypothesis and apparatus using the method, U.S. Pat. No. 4,896,358 makes a keyword model and a filler model, and executes a likelihood ratio test by using a generated score by the two models in order to reject a false hypothesis. However, in the automatic speech recognition system using the conventional technique, since the method of rejecting is seriously affected by an accuracy of the filler model and relies only on an average of an acoustic likelihood, information about a partial path is insufficient.

On the other hand, as an example of a conventional measuring system of confidence using a near-miss pattern, U.S. Pat. No. 6,571,210 makes a near-miss template for each word and calculates a confidence score by comparing a recognized near-miss pattern to the near-miss template. However, the conventional measuring system of confidence using the near-miss pattern is possible only when each word has a template, and largely relies on average acoustic likelihood information.

In this instance, in the method of measuring confidence of a speech recognizer using the conventional technique, since a likelihood score is a result value of the speech recognizer, when the speech recognizer misidentifies a speech, the method of measuring confidence using the misidentified result is queried with its confidence. Also, in a method of measuring confidence of a speech recognizer using the conventional technique, even if the likelihood score is high, a phase change of a speech signal in a waveform and a spectrogram may not be reflected.

Accordingly, a more accurate method of measuring confidence of speech recognition, which reflects on the phase change of the speech signal, is earnestly requested.

### SUMMARY OF THE INVENTION

Additional aspects, features, and/or advantages of the invention will be set forth in part in the description which follows and, in part, will be apparent from the description, or may be learned by practice of the invention.

An aspect of the present invention provides a method of measuring confidence of speech recognition by comparing a phase change point of a speech signal input to a speech recognizer and a phoneme string change point of a result of speech recognition and using the difference between the phase change point and the phoneme string change point, and a likelihood ratio, and an apparatus using the method.

An aspect of the present invention also provides a method of measuring confidence of speech recognition in a speech recognizer, the method including: detecting a phase change point of a speech signal; detecting a phoneme string change point according to a result of speech recognition of the speech signal; and calculating confidence of the speech recognition by using a difference between the detected phase change point and the detected phoneme string change point, and a likelihood ratio.

According to an aspect of the present invention, there is provided a method of measuring confidence of speech recognition of a speech recognizer, the method including: extracting a feature of a speech signal; calculating a spectrogram of the speech signal; recognizing a speech from the extracted feature of the speech signal by using a predetermined speech recognition model; comparing a phase change of the speech signal by using a result of speech recognition and the calculated spectrogram; calculating a likelihood ratio of the speech recognition according to the speech recognition model; and calculating confidence of the speech recognition by considering the phase change comparison and the likelihood ratio.

According to another aspect of the present invention, there is provided a measuring apparatus for confidence of speech recognition in a speech recognizer including: a phase change detection unit detecting a phase change point of a speech signal; a phoneme string change detection unit detecting a phoneme string change point according to a result of speech recognition in the speech recognizer; and a confidence calculation unit calculating confidence of the speech recognition by using a comparison result a detected phase change point with the detected phoneme string change point, and a likelihood ratio.

According to still another aspect of the present invention, there is provided a measuring apparatus of confidence of speech recognition in a speech recognizer including: a feature extraction unit extracting a feature of a speech signal; a spectrogram calculation unit calculating a spectrogram of the speech signal; a speech recognition unit recognizing a speech from a feature of the extracted speech signal by using a predetermined speech recognition model; a phase change comparison unit comparing phase changes of a speech signal by using a result of speech recognition and the calculated spectrogram; a likelihood ratio calculation unit calculating a likelihood ratio of the speech recognition according to the result of speech recognition; and a confidence measuring unit calculating confidence of the speech recognition by considering both the comparison result of the phase change and the likelihood ratio.

According to another aspect of the present invention, there is provided a method of measuring confidence of speech recognition including detecting a phase change point of a speech signal; detecting a phoneme string change point according to a result of speech recognition of the speech signal; and calculating confidence of the speech recognition by using a difference between the detected phase change point and the detected phoneme string change point.

According to another aspect of the present invention, there is provided a method of measuring confidence of speech recognition of a speech signal including calculating confidence of the speech recognition by using a difference between a phase change point of the speech signal and a phoneme string change point, and by using a likelihood ratio.

According to another aspect of the present invention, there is provided a measuring apparatus for confidence of speech recognition, the apparatus including a phase change detection unit detecting a phase change point of a speech signal; a phoneme string change detection unit detecting a phoneme string change point according to a result of speech recognition in the speech recognizer; and a confidence calculation unit calculating confidence of the speech recognition by using a comparison result a detected phase change point with the detected phoneme string change point.

According to another aspect of the present invention, there is provided at least one computer readable medium comprising computer readable instructions implementing methods of the present invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. These and/or other aspects, features, and advantages of the invention will become apparent and more readily appreciated from the following description of the embodiments, taken in conjunction with the accompanying drawings of which:

FIG. 1 is a diagram illustrating a configuration for a calculating apparatus of a phase change score in a speech recognizer according to an exemplary embodiment of the present invention;

FIG. 2 is a diagram illustrating a configuration of a speech recognizer according to an exemplary embodiment of the present invention;

FIG. 3 is a diagram illustrating an exemplary embodiment measuring confidence using a likelihood ratio by a keyword model and a filler model in a speech recognizer according to the present invention;

FIG. 4 is a diagram illustrating an exemplary embodiment of a spectrogram for an input speech signal in a speech recognizer according to the present invention;

FIG. 5 is a diagram illustrating an exemplary embodiment of an estimated phase change point according to Euclidian distance between a pair of frames on a spectrogram illustrated in FIG. 4;

FIG. 6 is a diagram illustrating an exemplary embodiment comparing a phase change point with a phoneme string change point in an apparatus of measuring confidence of a speech recognizer according to the present invention.

FIG. 7 is a flowchart illustrating a method of calculating a phase change score in a speech recognizer according to an exemplary embodiment of the present invention; and

FIG. 8 is a flowchart illustrating a method of measuring confidence of speech recognition in a speech recognizer according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below in order to explain the present invention by referring to the figures.

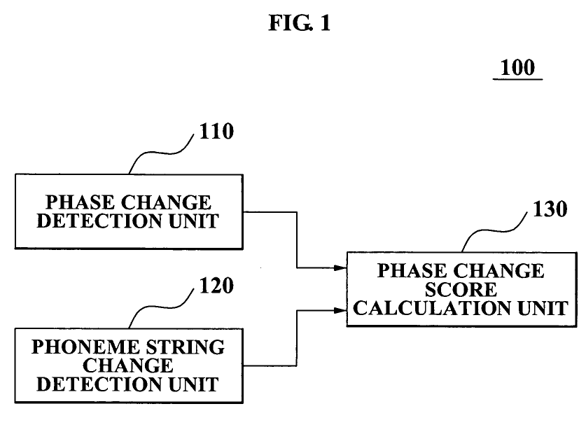

FIG. 1 is a diagram illustrating a configuration for an apparatus of calculating a phase change score in a speech recognizer according to an exemplary embodiment of the present invention.

Referring to FIG. 1, an apparatus of calculating a phase change score 100 includes a phase change detection unit 110, a phoneme string change detection unit 120 and a phase change score calculation unit 130.

The phase change detection unit 110 detects a phase change point of a speech signal input to the speech recognizer.

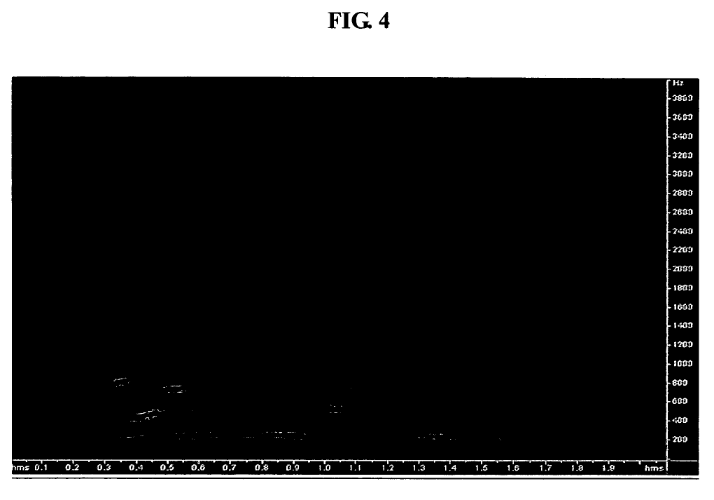

The phase change detection unit 110, an exemplary embodiment of detecting a phase change, detects a candidate for a phase change point of the speech signal by using a difference between a peak and a valley on a spectrogram, as illustrated in FIG. 4, for the speech signal.

The spectrogram illustrated in FIG. 4 can be used in the phase change detection unit 110. Also, a waveform or various types of speech feature spaces may be used in order to detect a phase change point for a speech signal.

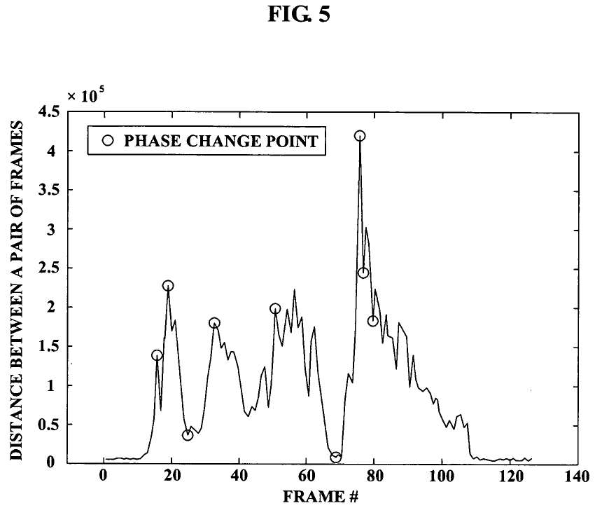

Namely, the phase change detection unit 110 calculates a Euclidian distance between a pair of frames in the spectrogram of the speech signal. Also, the phase change detection unit 110, as shown in FIG. 5, detects a phase change point of the speech signal by searching N-topper points of which a distance between the a peak and a valley of a graph, as indicated by the value of the Euclidian distance, as a phase change point. With respect to the phase change detection unit 110, for example, when a word such as ‘mother’ is input to the speech recognizer, a spectrogram of a speech signal matching the word such as ‘mother’ is analyzed. According to a result of an analysis of the spectrogram, the phase change point of the speech signal may be detected.

A phoneme string change detection unit 120 detects a phoneme string change point according to a result of speech recognition of the speech signal input from the speech recognizer. That is, the phoneme string change detection unit 120 recognizes the speech signal input from the speech recognizer by a predetermined speech recognition model and detects the phoneme string change point for the recognized speech signal.

With respect to the phoneme string change detection unit 120, for example, when a word of ‘mother’ is input to the speech recognizer and phoneme strings, such as ‘m’, ‘o’, ‘t’, ‘h’, ‘e’, ‘r’, are recognized, the recognized phoneme string change point may be detected by the predetermined speech recognition model.

A phase change score calculation unit 130 calculates a phase change score of the speech signal by comparing the detected phase change point with the detected phoneme string change point. In other words, when calculating a score of the phase change point, the phase change scoring unit 130 compares the detected phase change point with the detected phoneme string change point, gives a penalty score to a matched point, and reflects the given penalty score in the case a difference is above a predetermined reference value.

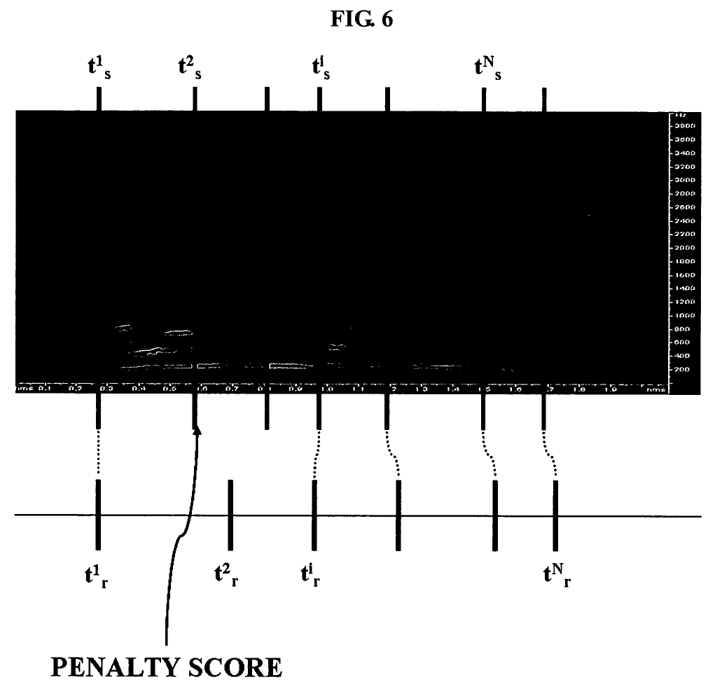

For example, as illustrated in FIG. 6, when the detected phase change point in the spectrogram is not matched with regard to the detected phoneme string change point, the penalty scored is given and the phase change score is calculated, by the phase change score calculation unit 130, according to the given penalty score.

As described above, an apparatus of measuring confidence according to the present invention is able to more accurately measure confidence of speech recognition by utilizing a phase change and a likelihood ratio of a speech signal. On the other hand, an apparatus using a conventional technique only utilizes a likelihood ratio of the speech signal recognized by a speech recognition model.

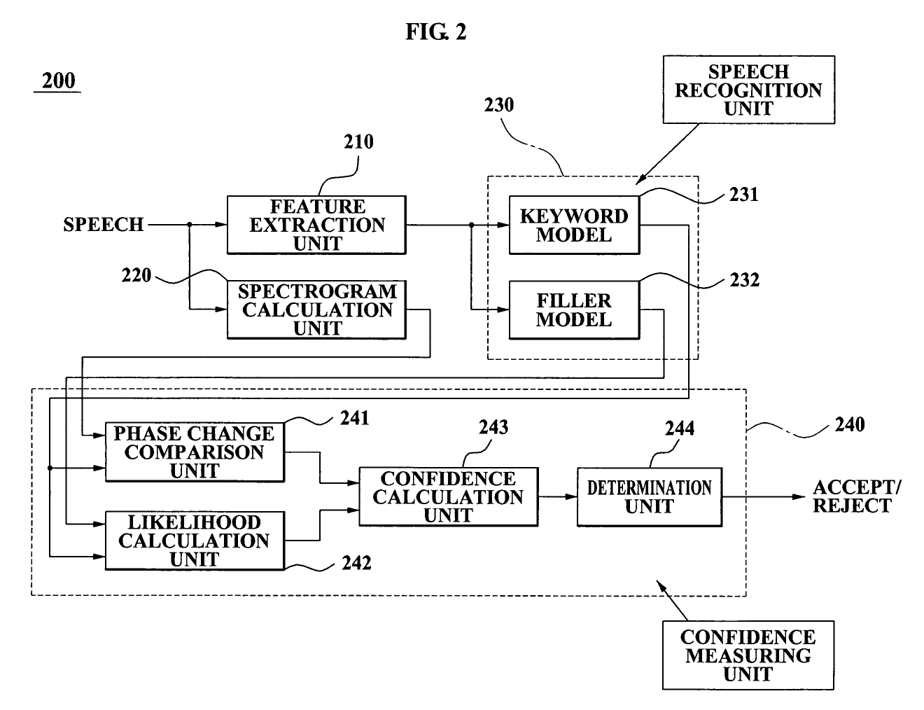

FIG. 2 is a diagram illustrating a configuration of a speech recognizer according to an exemplary embodiment of the present invention.

Referring to FIG. 2, a speech recognizer 200 includes a feature extraction unit 210, a spectrogram calculation unit 220, a speech recognition unit 230 and a confidence measuring unit 240.

The feature extraction unit 210 extracts a feature of a speech signal input to the speech recognizer 200.

The spectrogram calculation unit 220 calculates a spectrogram for the input speech signal. The spectrogram, as illustrated in FIG. 4, is an exemplary embodiment showing a phase change feature of the speech signal.

The speech recognition unit 230 recognizes a speech from the extracted feature of the speech signal by using a predetermined speech recognition model. The speech recognition model includes a keyword model 231 and a filler model 232. Namely, the speech recognition unit 230 recognizes a speech from the extracted feature of the speech signal by using the key word model 231 and the filler model 232.

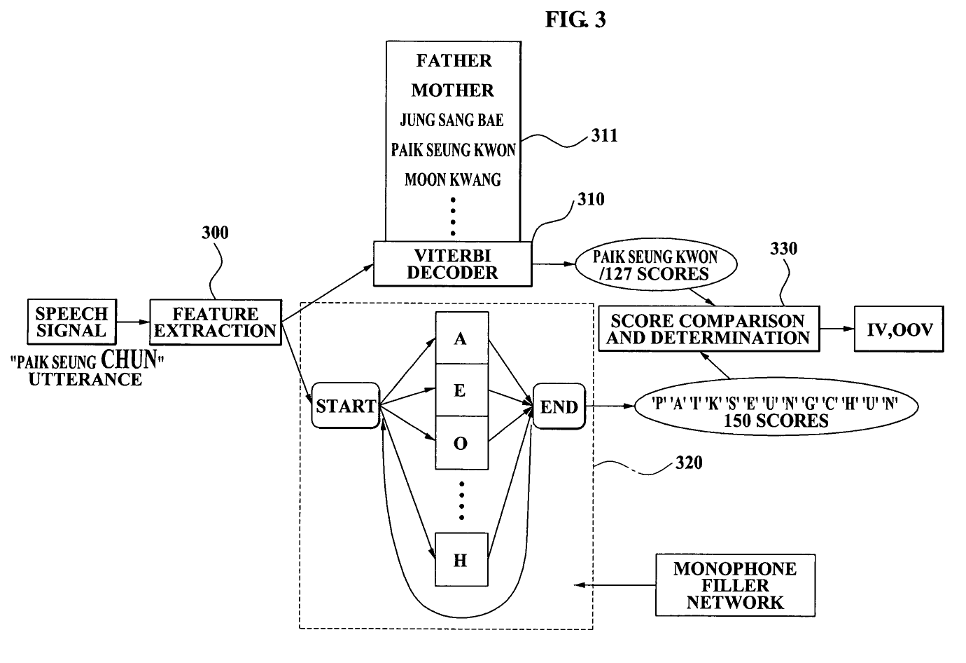

FIG. 3 is a diagram illustrating an exemplary embodiment measuring confidence using a likelihood ratio by the keyword model and the filler model in the speech recognizer 200 according to the present invention. Referring to FIG. 3, in an operation of a feature extracting 300, for example, when a speech signal of ‘Paik Seung Chun’ is input, features are extracted from the input speech signal. With reference to an exemplary method of recognizing a speech by a keyword model 231 in the speech recognizer 200, after decoding the extracted speech signal through a viterbi decoder 310, a speech of ‘Paik Seung Kwon’ having the most similar feature to the decoded speech feature from words stored in a recognition list 311 is recognized.

Also, in an exemplary method of recognizing the speech in the speech recognizer 200 by the filler model 232, the extracted feature of the speech signal is recognized as each phoneme through a monophone filler network 320 by using the extracted feature of the speech signal.

In operation 330, for example, when a result/score of the speech recognition recognized by the keyword model 231 is ‘paik seung kwon/127 scores’, the phoneme/score recognized by the filler model 232 is ‘paik seung chun/150 scores’, score difference are compared so that the recognizer 200 may determine whether a result of speech recognition is IV (in vocabulary) or OOV (out of vocabulary) of the speech recognition. Namely, the recognizer 200 compares the result of speech recognition by the keyword model 231 and the filler model 232 and a likelihood ratio, according to the comparison result, and the input speech signal is determined to be correct or not.

The confidence measuring unit 240 includes a phase change comparison unit 241, a likelihood calculation unit 242, a confidence calculation unit 243 and a determination unit 244. The confidence measuring unit 240 measures confidence for the recognized speech signal by using a spectrogram calculated in the spectrogram calculation unit 220 and a speech signal recognized in the speech recognition unit 230.

The phase change comparison unit 241 compares a phoneme string change point which is a result of speech recognition by the keyword model with the closest phase change point of the spectrogram within a predetermined range, according to the comparison result, and gives a penalty score to an unmatched point with respect to the phoneme string change point among the N-topper points of which distance is longer than the other points according to the comparison result.

FIG. 6 is a diagram illustrating an exemplary embodiment comparing a phase change point with a phoneme string change point in an apparatus of measuring confidence of a speech recognizer according to the present invention.

Referring to FIG. 6, the phase change comparison unit 241 compares phase change points of t¹ₛ, t²ₛ, tⁱₛ, t^{N}ₛ by a spectrogram with phoneme string change points of t¹ᵣ, t²ᵣ, tⁱᵣ, t^{N}ᵣ by a recognized result and a penalty score is given according to differences of a comparison result of the points.

In the phase change comparison unit 241, when the first phase change point of t¹ₛ by the spectrogram is compared with the first phoneme string change point of t¹ᵣ recognized by the keyword model 231, both first change points match each other, therefore a penalty score is not given. On the other hand, in the phase change comparison unit 241, when the second phase change point of t²ₛ by the spectrogram is compared with the second phoneme change point of t²ᵣ recognized by the keyword model 231, a difference between the both second change points is greater than a reference value according to the comparison result, therefore a penalty score is given.

A likelihood ratio calculation unit 242 calculates a likelihood ratio of the speech recognition according to the result of speech recognition. That is, the likelihood ratio calculation unit 242 calculates a likelihood ratio of the speech signal according to the result of speech recognition by the keyword model 231 and the result of speech recognition by the filler model 232.

The confidence calculation unit 243 calculates confidence of the speech recognition by not only taking the likelihood ratio calculated in the likelihood ratio calculation unit 242 into consideration, but also taking the comparison result of the phase compared in the phase change comparison unit 241 into consideration. Namely, the confidence calculation unit 243 calculates confidence by using the phase change score calculated by the phase change calculation unit 241 and the likelihood ratio calculated in the likelihood ratio calculation unit 242. The confidence is given by equation 1 shown below.

$$CS ( X ) = f ( \frac{P ( X \vert {H}_{word} )}{P ( X \vert {H}_{filler} )} , PCS ) \\ PCS = {\sum }_{i}^{N} ( {t}_{r}^{i} - {t}_{s}^{i} ) + K * PS \qquad [ Equation 1 ]$$

In this instance, the tⁱᵣ indicates the i^{th} of a phoneme change point in speech recognition, the tⁱₛ indicates the i^{th} of a phase change point of a spectrogram, N indicates a number of change points to be compared, PS indicates a penalty score, K indicates a number of phase change points to be penalty scored, f indicates a transfer function of a likelihood ratio score and a phase change score.

The determination unit 244 determines whether to accept or to reject the speech recognized in the speech recognizer 200 according to the confidence calculated in the confidence calculation unit 243. Namely, when the calculated confidence is greater than a predetermined reference value, the determination unit 244 determines to accept the speech recognized in the speech recognizer 200. Also, when the calculated confidence is less than the predetermined reference value, the determination unit 244 determines to reject the recognized speech.

As illustrated above, according to an exemplary method of measuring confidence of a speech recognizer of the present invention, confidence for a speech recognition is more accurately measured since not only a likelihood ratio of the speech signal recognized according to a rough speech recognition model is taken into consideration, but also phase changes of a speech signal are taken into consideration, and whether to accept the recognized speech or to reject is determined according to the measured confidence. Consequently, a more accurate speech recognition may be executed.

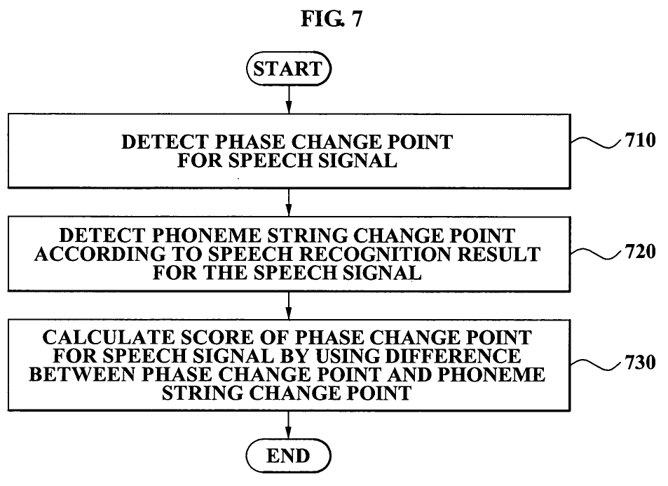

FIG. 7 is a flowchart illustrating a method of calculating a phase change score in a speech recognizer according to an exemplary embodiment of the present invention.

Referring to FIG. 7, in operation 710, a speech recognizer 200 detects a phase change point of a speech signal. Namely, in operation 710, the speech recognizer 200 detects a phase change point, such as a spectrogram of the speech signal, a waveform and a spatial feature, of the speech signal.

In operation 710, when the speech recognizer 200 uses the spectrogram of the speech signal as an exemplary embodiment of detecting a phase change point of the speech signal, after calculating a Euclidian distance between frames on a spectrogram illustrated in FIG. 4, a phase change point of the speech signal is detected by using a peak and a valley in a graph according to the calculated Euclidian distance. That is, in operation 710, the speech recognizer 200 is able to detect the phase change point of the speech signal by using N-topper points of which distance between the peak and valley are greater than the other points as illustrated in FIG. 5.

In operation 720, the speech recognizer 200 detects a phoneme string change point according to a result of speech recognition of the speech signal.

In operation 730, the speech recognizer 200 calculates a score of a phase change point of the speech signal by using a difference between the detected phase change point and the detected phoneme string change point. Namely, in operation 730, the speech recognizer 200 locates an unmatched point with respect to the detected phoneme string change point among the N-topper points and calculates a phase change score of the speech recognition by giving a penalty score to the unmatched point.

As illustrated above, according to an exemplary method of measuring confidence for a speech recognition of the present invention, confidence for a speech recognition is more accurately measured since not only a likelihood ratio of the recognized speech signal by a rough speech recognition model is utilized, but also both a phase change of a speech signal and a likelihood ratio are simultaneously utilized.

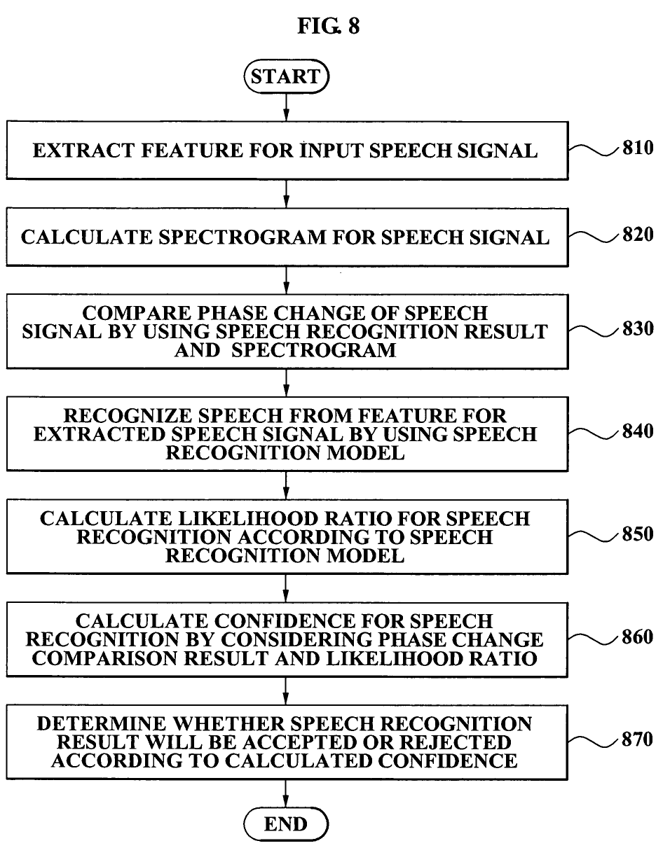

FIG. 8 is a flowchart illustrating an exemplary embodiment of a method of measuring confidence of speech recognition in the speech recognizer 200 according to the present invention. Referring to FIG. 8, in operation 810, the speech recognizer 200 extracts a feature of the input speech signal.

In operation 820, the speech recognizer 200 calculates a spectrogram of the speech signal. Namely, in operation 820, the speech recognizer 200 calculates a spectrogram, which is one feature of a speech signal for locating a phase change point of the input speech signal. Also, in operation 820, the speech recognizer 200 may include a waveform and features which can locate a phase change point of the speech signal including the spectrogram.

In operation 830, the speech recognizer 200 recognizes a speech from a feature of the extracted speech signal by using the predetermined speech recognition model. The speech recognition model includes the keyword model and the filler model. Namely, in operation 830, the speech recognizer 200 recognizes the speech for the input speech signal from the feature for the extracted speech signal by using the predetermined speech recognition model.

In operation 840, the speech recognizer 200 compares phase changes of the speech signal by using a result of speech recognition with the calculated spectrogram. In other words, in operation 840, the recognizer 200 compares a phoneme string change point, which is a result of speech recognition according to the keyword model, with the closest phase change point of the spectrogram within the predetermined range, and gives a penalty score to a unmatched point with regard to the phoneme string change point among the N-topper points of which distance is greater than the other points according to the comparison result.

In operation 840, as shown in FIG. 6, the speech recognizer 200 may give a penalty score to the phase change point when a difference is above the predetermined reference value after comparing a phase change point by the spectrogram with a phoneme string change point by the speech recognition.

In operation 850, the speech recognizer 200 calculates a likelihood ratio of the speech recognition according to the speech recognition model. Namely, in operation 850, the speech recognizer 200 calculates a likelihood ratio of the speech recognition according to the keyword model and the filler model.

In operation 860, the speech recognizer 200 calculates confidence of the speech recognition by accounting for the comparison result of the phase change and the likelihood.

In operation 870, the speech recognizer 200 determines whether to accept or reject the result of speech recognition according to the calculated confidence.

Namely, in the operation 870, the speech recognizer 200 may determine to accept the result of speech recognition when the calculated confidence is above the predetermined reference value. Also, in operation 870, the speech recognizer 200 may determine to reject the result of speech recognition when the calculated confidence is below the predetermined reference value.

As illustrated above, an exemplary method of measuring confidence of speech recognition of a speech recognizer according to the present invention may calculate confidence more accurately of speech recognition since a likelihood and a value compared a phase change point of a speech signal with a recognized phoneme string change point are simultaneously utilizing for calculating the confidence, according to the calculated confidence, and whether to accept or reject a result of speech recognition is determined.

A method of measuring confidence of speech recognition of a speech recognizer according to the present invention may be embodied as a program instruction capable of being executed via various computer units and may be recorded in a computer-readable storage medium. The computer-readable storage medium may include a program instruction, a data file, and a data structure, separately or cooperatively. The program instructions and the media may be those specially designed and constructed for the purposes of the present invention, or they may be of the kind well-known and available to those skilled in the art of computer software. Examples of the program instructions include both machine code, such as produced by a compiler, and files containing high-level language codes that may be executed by the computer using an interpreter. The hardware elements above may be configured to act as one or more software modules for implementing the operations of this invention.

Exemplary embodiments of the present invention can be implemented by executing computer readable code/instructions in/on a medium, e.g., a computer readable medium. The medium can correspond to any medium/media permitting the storing and/or transmission of the computer readable code/instructions.

The computer readable code/instructions can be recorded/transferred in/on a medium in a variety of ways, with examples of the medium including magnetic storage media (e.g., floppy disks, hard disks, magnetic tapes, etc.), optical media (e.g., CD-ROMs, DVDs, etc.), magneto-optical media (e.g., floptical disks), hardware storage devices (e.g., read only memory media, random access memory media, flash memories, etc.) and storage/transmission media such as carrier waves transmitting signals, which may include instructions, data structures, etc. Examples of storage/transmission media may include wired and/or wireless transmission (such as transmission through the Internet). Examples of wired storage/transmission media may include optical wires/lines, metallic wires/lines, waveguides, etc. The medium/media may also be a distributed network, so that the computer readable code/instructions is stored/transferred and executed in a distributed fashion. The computer readable code/instructions may be executed by one or more processors.

According to the present invention, a measuring performance of confidence may become higher since not only a likelihood ratio is taken into consideration, but also a comparison result of a phase change of a speech signal and a phoneme string change point according to a result of speech recognition of a speech recognizer are utilized.

Also, according to the present invention, an incorrect response of a speech recognizer may become minimized since confidence is accurately measured so that a user's inconvenience may become decreased.

Also, according to the present invention, a user's confidence for a product using speech recognition may be improved by preventing the product from malfunctioning caused by incorrect speech recognition.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of measuring confidence of speech recognition in a speech recognizer, the method comprising:
detecting a phase change point of a speech signal;
detecting a phoneme string change point according to a result of speech recognition of the speech signal; and
calculating confidence of the speech recognition by using a difference between the detected phase change point and the detected phoneme string change point, and a likelihood ratio.

2. The method of claim 1, wherein the detecting a phase change point of a speech signal detects the phase change point of the speech signal from one of a spectrogram, a waveform, and a feature of the speech signal.

3. The method of claim 2, wherein the detecting a phase change point of a speech signal comprising:
calculating a Euclidian distance between a pair of frames in the spectrogram for the speech signal; and
detecting the phase change point for the speech signal by using a calculated peak and a valley.

4. The method of claim 3, wherein the detecting a phase change point of the speech signal comprises detecting the phase change point of the speech signal by using the N-topper points of which calculated distance between the peak and the valley are higher than other points.

5. The method of claim 4, wherein the calculating confidence of the speech recognition locates an unmatched point with respect to the detected phoneme string change point among the N-topper points and calculates the confidence of the speech recognition by giving a penalty score to the unmatched point.

6. The method of claim 1, wherein the calculating confidence of the speech recognition calculates the confidence of the speech recognition by using a phase change score according to the difference and the likelihood ratio of the speech recognition.

7. A method of measuring confidence of speech recognition of a speech recognizer, the method comprising:
extracting a feature of a speech signal;
calculating a spectrogram of the speech signal;
recognizing a speech from the extracted feature of the speech signal by using a predetermined speech recognition model;
comparing a phase change of the speech signal by using a result of speech recognition and the calculated spectrogram;
calculating a likelihood ratio of the speech recognition according to the speech recognition model; and
calculating confidence of the speech recognition by considering the phase change comparison and the likelihood ratio.

8. The method of claim 7, wherein the speech recognition unit recognizes the speech through a keyword model and a filler model from the extracted feature.

9. The method of claim 8, the comparing a phase change of the speech signal by using the result of speech recognition and the calculated spectrogram comprising:
comparing a phoneme string change point which is a result of speech recognition by the keyword model with the closest phase change point of the spectrogram within a predetermined range; and
giving a penalty score to an unmatched point with respect to the phoneme string change point among N-topper points of which distance is longer than the other points according to the comparison result.

10. The method of claim 8, wherein the method further determines whether to accept the recognized speech signal or not according to the calculated confidence.

11. A computer readable storage medium storing a program for implementing the method of claim 1.

12. A measuring apparatus for confidence of speech recognition in a speech recognizer, the apparatus comprising:
a phase change detection unit detecting a phase change point of a speech signal;
a phoneme string change detection unit detecting a phoneme string change point according to a result of speech recognition in the speech recognizer; and
a confidence calculation unit calculating confidence of the speech recognition by using a comparison result a detected phase change point with the detected phoneme string change point, and a likelihood ratio.

13. The apparatus of claim 12, wherein the phase change detection unit detects a phase change point of the speech signal from a spectrogram and a waveform of the speech signal and a feature of the speech signal.

14. The apparatus of claim 13, wherein the phase change detection unit detects a phase change point of the speech signal on a spectrogram of the speech signal by using a calculated peak and a valley.

15. The apparatus of claim 12, wherein the confidence calculation unit calculates the confidence by giving penalty scores when the detected phase change point in the spectrogram is not matched to the detected phoneme string change point

16. A measuring apparatus of confidence of speech recognition in a speech recognizer, the apparatus comprising:
a feature extraction unit extracting a feature of a speech signal;
a spectrogram calculation unit calculating a spectrogram of the speech signal;
a speech recognition unit recognizing a speech from a feature of the extracted speech signal by using a predetermined speech recognition model;
a phase change comparison unit comparing phase changes of a speech signal by using a result of speech recognition and the calculated spectrogram;
a likelihood ratio calculation unit calculating a likelihood ratio of the speech recognition according to the result of speech recognition; and
a confidence measuring unit calculating confidence of the speech recognition by considering both the comparison result of the phase change and the likelihood ratio.

17. The apparatus of claim 16, wherein the speech recognition unit recognizes the speech through a keyword model and a filler model from the extracted feature.

18. The apparatus of claim 17, wherein the phase change comparison unit comprises:
comparing a phoneme string change point which is a result of speech recognition by the keyword model with the closest point of the phase change of the spectrogram within a predetermined range; and
giving a penalty score to an unmatched point with respect to the phoneme string change point among N-topper points of which distance is longer than other points according to the comparison result.

19. The apparatus of claim 16, wherein the method further comprises a determination unit determining whether to accept the recognized speech signal or not according to the calculated confidence.

20. At least one computer readable medium comprising computer readable instructions implementing the method of claim 7.

21. A method of measuring confidence of speech recognition of a speech signal comprising calculating confidence of the speech recognition by using a difference between a phase change point of the speech signal and a phoneme string change point, and by using a likelihood ratio of the speech signal.

22. At least one computer readable medium comprising computer readable instructions implementing the method of claim 21.
